(19) United States
(12) Patent Application Publication
(10) Pub. No.: US 2005/0164659 A1
(43) Pub. Date: Jul. 28, 2005

(54) Apparatus and method for correcting sudden phase changes in received signals in mobile stations

(75) Inventors: Attila Bilgic, Kirchheim (DE); Bertram Gunzelmann, Konigsbrunn (DE); Dietmar Wenzel, Munchen (DE); Robert Wurth, Munchen (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Infineon Technologies AG

(21) Appl. No.: 10/854,661

(22) Filed: May 26, 2004

Related U.S. Application Data
(63) Continuation of application No. PCT/DE02/03906, filed on Oct. 15, 2002.

(30) Foreign Application Priority Data
Nov. 27, 2001 (DE) 101 58 079.7

(51) Int. Cl. H04B 1/04

(52) U.S. Cl. 455/126; 375/371

(57) ABSTRACT

To correct sudden phase changes, a device for phase correction (20) and a common control unit (10) are described, the latter switching the gain factor for the amplifier stage (30) and, at times coordinated with this, delivering phase correction values of suitable size to the device for phase correction (20), where the control unit (10) uses knowledge about fixed parameters, such as delay times and properties of sudden phase changes, when changing over the amplifier stages.

### CROSS REFERENCE TO RELATED APPLICATION

This application is a continuation of copending International Application No. PCT/DE02/03906 filed Oct. 15, 2002 which designates the United States, and claims priority to German application no. 101 58 079.7 filed Nov. 27, 2001.

### TECHNICAL FIELD OF THE INVENTION

The present invention generally relates to the field of mobile radio receiver circuits and, in particular, concerns a method and an apparatus for correcting sudden phase changes in received signals.

### DESCRIPTION OF RELATED ART AND BACKGROUND OF THE INVENTION

Radio frequency receiver circuits in mobile stations normally contain, on the basis of the current prior art, amplifier stages, “low noise amplifiers” (LNA), having two or more switchable gain factors. By way of example, the amplifier stage can be configured for two gain factors, one with +15 dB, the other with −5 dB, in order to take into account the respective reception field strengths, which are dependent on many parameters, but particularly on the distance to the next base station, and to actuate the receiver in the mobile station in the best possible manner.

Changeover between the gain factors usually entails a sudden phase change in the output signal, since the amplifier stage has, by way of example, a different group delay time for the individual gain factors, or other phase changes related to circuitry arise. These sudden phase changes impair the performance of the reception system to a considerable degree, since the data transferred at times close to the sudden phase change are misinterpreted by the receiver. When the amplifier stage is changed over frequently, the bit error rate thus increases significantly.

In previously known systems, no special correction or compensation for sudden phase changes was performed. Instead, the ability of the signal receiver, e.g. the “equalizer” in the case of GSM and EDGE compatible signals and the “rake receivers” in the case of UMTS compatible signals, was used to correct phase changes comparatively slowly. The very complex algorithm used in these cases means that regulation is usually sluggish and can therefore react only unsatisfactorily to fast and large sudden phase changes. To date, the received signal cannot therefore be evaluated correctly in a comparatively long period of time, which results in a corresponding increase in the bit error rate.

### SUMMARY OF THE INVENTION

It is thus an object of the present invention to specify a method or to describe a corresponding apparatus which can correct or compensate for sudden phase changes in the received signal in order to ensure virtually unimpaired reception despite the gain factors being changed over.

In this context, the following further conditions and problems, which likewise need to be solved as far as possible, apply:

a) Sudden phase changes need to be corrected or compensated for until the phase error is negligible.

b) The correction or compensation needs to be performed using exclusively digital means.

c) The correction needs to be performed quickly, i.e. much more quickly than for an “equalizer” or a “rake receiver”.

d) The flow of signals must not be interrupted in this case.

e) The method needs to be compatible with existing analog amplifier circuits and their actuation circuits.

f) Already available means for correcting the frequency of the received signal also need to be used for correcting sudden phase changes.

g) The devices which are required for correcting sudden phase changes need to be able to be integrated in the same chip as the digital part of the signal receiver.

h) No additional connection on the chip must be required.

i) The apparatus and the method are intended to be suitable, in particular, for use in mobile stations based on the standards GSM, EDGE, UMTS FDD, UMTS TDD and TIA/EIA-136 (IS-136).

This object and the further conditions and problems can be achieved by an apparatus for correcting sudden phase changes in received signals in mobile stations, wherein the mobile station's reception path comprises switchable components having at least two switchable states which produce sudden phase changes in the received signal upon changeover, wherein these sudden phase changes being able to be corrected by a device for phase correction, and wherein a system control unit transmits the parameters required for this, particularly the level of the sudden phase change and the time of the sudden phase change, to the device for phase correction.

The system control unit can be designed such that it changes over the switchable components, particularly the gain factor for the amplifier stage, and that it uses this property to determine the time of the sudden phase change. The unit for phase correction simultaneously may perform both correction of sudden phase changes and frequency correction. The unit for phase correction may contain a structure which is based on the principle of the CORDIC algorithm. The unit for phase correction may contain a structure which specifically implements phase corrections of 0°, 90° and −90° or else 180° without a multiplier. Precisely one multiplexer can be provided for processing the normal and quadrature components using time-division multiplexing. The unit for phase correction by 0°, 90°, −90° or 180° can be combined with a unit for frequency correction which is based on the principle of the CORDIC algorithm. The unit for phase correction by 0°, 90°, −90° or 180° can be implemented using means for analog signal processing and, in particular, is integrated on the chip which contains the switchable analog components. The apparatus can be integrated in the same chip as the digital signal receiver.

The object can also be achieved by a mobile station having such an apparatus which supports, in particular, the standards UMTS FDD, UMTS TDD, GSM (GMSK modulation), EDGE (3π/8-8 PSK modulation) and also TLA/EIA-136 (π/4-DQPSK modulation or 8-PSK modulation) or part combinations thereof.

The object can furthermore be achieved by a method for correcting sudden phase changes in received signals in mobile stations, comprising the steps of:
producing in the mobile station's reception path sudden phase changes in the received signal when switchable components having at least two switchable states change over, and
correcting the sudden phase changes by a device for phase correction, and transmitting the parameters required for this by a system control unit, particularly the level of the sudden phase change and the time of the sudden phase change, to the device for phase correction.

The system control unit also may change over the switchable components, particularly the gain factor for the amplifier stage, and, in particular, may use this property to determine the time of the sudden phase change. The unit for phase correction may simultaneously perform both correction of sudden phase changes and frequency correction. The unit for phase correction may contain a structure which is based on the principle of the CORDIC algorithm. The unit for phase correction may contain a structure which specifically implements phase corrections of 0°, 90° and −90° or else 180° without a multiplier. The normal and quadrature components can be processed using time-division multiplexing, and only one multiplexer is used. The unit for phase correction by 0°, 90°, −90° or 180° can be combined with a unit for frequency correction which is based on the principle of the CORDIC algorithm. The unit for phase correction by 0°, 90°, −90° or 180° can be implemented using means for analog signal processing and, in particular, is integrated on the chip which contains the switchable analog components. The arrangement or the method can be integrated in the same chip as the digital signal receiver. The method can be used in mobile stations which support, in particular, the standards UMTS FDD, UMTS TDD, GSM (GMSK modulation), EDGE (3π/8-8 PSK modulation) and also TIA/EIA-136 (π/4-DQPSK modulation or 8-PSK modulation) or part combinations thereof.

A fundamental concept of the invention is the use of a device for phase correction and a common control unit, the latter switching the gain factor for the amplifier stage and, at times coordinated with this, delivering phase correction values of suitable size to the device for phase correction, where the control unit uses knowledge about fixed parameters, such as delay times and properties of sudden phase changes, when changing over the amplifier stages, specifically such that at least the aforementioned condition a) is satisfied.

### BRIEF DESCRIPTION OF THE DRAWINGS

The invention is explained in more detail below with reference to the figures of the drawing, in which:

FIG. 1 shows a general embodiment of an apparatus in accordance with the invention;

FIG. 2 shows a further embodiment with an additional frequency correction section;

FIG. 3 shows an embodiment with an additional frequency correction section as an alternative to the embodiment shown in FIG. 2;

FIG. 4 shows a general embodiment of the unit for correcting sudden phase changes which is provided in the inventive apparatus;

FIG. 5 shows the structure of a multiplier-free arrangement for the unit for phase and frequency correction shown in FIG. 2 or 3;

FIG. 6 shows a specific, low-complexity embodiment of the unit for correcting sudden phase changes which is provided in the inventive apparatus;

FIG. 7 shows a further low-complexity embodiment of the unit for correcting sudden phase changes which is provided in the inventive apparatus;

FIG. 8 shows a graph to illustrate the phase rotation by the unit for correcting sudden phase changes which is shown in FIG. 6;

FIG. 9 shows a graph to illustrate the phase rotation by the unit for correcting sudden phase changes which is shown in FIG. 6;

FIG. 10 shows a further arrangement for the unit for phase and frequency correction with a frequency correction element which uses the CORDIC algorithm.

### DETAILED DESCRIPTION OF EMBODIMENTS

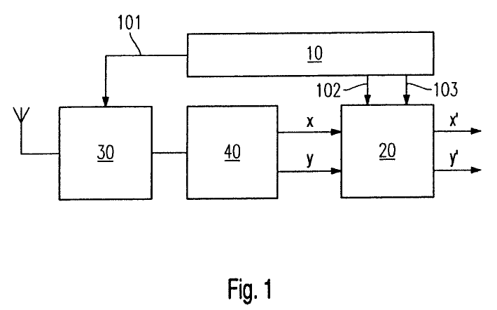

The general embodiment of the invention has, as shown in FIG. 1, an amplifier stage 30 for amplifying the received signal using at least two different switchable gain factors, which can be switched using the associated switching signal 101.

In addition, the general embodiment of the invention has at least one device for phase correction 20 in the complex-value reception signal path downstream of the demodulator and A/D converter 40, and also a system control unit 10 which outputs controlled variables 102, 103 for the phase correction and the switching signal 101 for the amplifier stage.

This general embodiment shown in FIG. 1 achieves the object of the present invention and, in addition, satisfies the conditions a)-i) listed above and solves the problems cited therein, giving the following advantages:

a) The system control unit 10 itself changes over between the gain factors for the amplifier stage 30 and therefore knows the exact time of changeover. This means that the system control unit is advantageously able to ascertain the time at which the sudden phase change in the received signal appears at the input of the device for phase correction 20. The delay times of the demodulator and the A/D converter 40 are in this case fixed, deterministic system variables which are known to the system control unit. For this reason, the system control unit 10 can notify the unit for phase correction 20 of the time at which correction is required using a control signal 102.

b) The level of the sudden phase changes which arise when changing over from one amplifier to the other are likewise fixed, deterministic system variables and are similarly known to the system control unit 10. For this reason, the system control unit 10 can notify the unit for phase correction 20 of the level of the sudden phase change which needs to be corrected using a further control signal 103.

c) Following the correction, ideally no sudden phase change is visible any longer, or just a small sudden change remains which can be corrected sufficiently quickly by the subsequent receiver, so that no significant bit errors can arise. The receiver is thus unburdened by the inventive arrangement, and an improved bit error rate is obtained at the same time.

In addition, the invention can have the following features, as will be seen in detail in the exemplary embodiments:

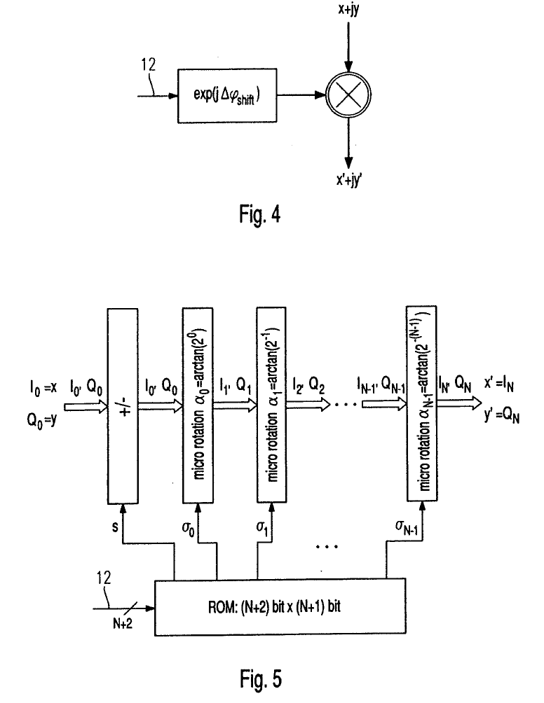

d) In the most general case, the device for correcting sudden phase changes 20 can contain a complex multiplier as shown in FIG. 4, which rotates the input values using a complex rotation factor exp(jΔφ_{SHIFT}) and thus compensates for the sudden phase change.

e) Instead of a complex multiplier, an arrangement may also be implemented which performs the rotation without a multiplier using the CORDIC algorithm shown in FIG. 5, as described in German laid-open specification DE 199 48 899 A1, which is incorporated hereby in its entirety in the disclosed content of the present application.

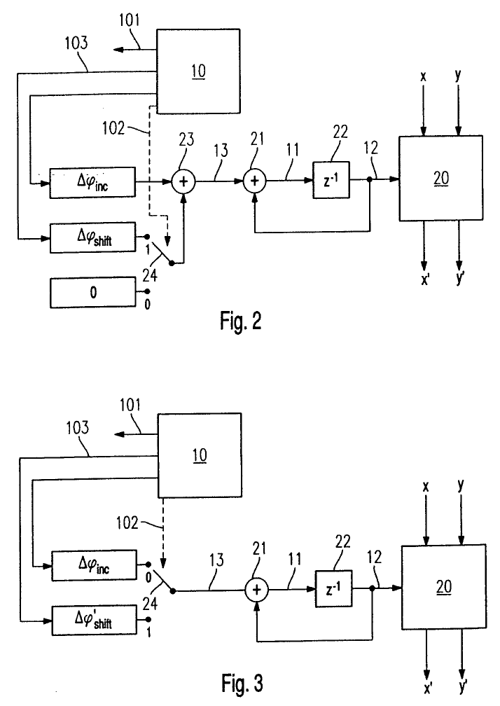

f) The device for correcting sudden phase changes can simultaneously be used as a frequency correction element if, in line with FIG. 2 and FIG. 3, a phase accumulator, comprising an adder stage 21 fed back via a delay element 22, is connected upstream of the device for correcting sudden phase changes 20. For frequency correction, a particular phase increment Δφ_{INC} is prescribed as input variable for the phase accumulator. If a sudden phase change needs to be corrected at the same time, the sudden phase change's correction value Δφ_{SHIFT} is added once, using an additional adder 23, to the input signal for the phase accumulator, as shown in FIG. 2. Alternatively, the phase increment Δφ_{INC} can be modified once or can be changed over for one operating clock cycle to another value Δφ′_{SHIFT} using the multiplexer 24, as shown in FIG. 3. An advantage of this embodiment is that the fed-back adder stage acting as an integrator means that an action needs to be performed only once in order to correct a sudden phase change, and the phase correction is permanently effective. In addition, the current phase correction value is not dependent on the preceding events.

The present invention can have the following additional special features:

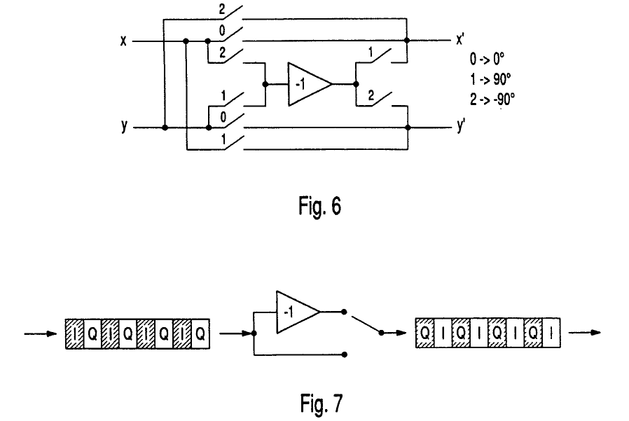

a) In many instances of application, only sudden phase changes of 0°, 90° or −90° arise. In these cases, a particularly efficient multiplier-free structure as shown in FIG. 6, containing just switches and an inverter, may be used in the inventive arrangement.

b) If the samples in case a) are not processed in parallel, i.e. simultaneously, but rather using time-division multiplexing for the normal (I) and quadrature (Q) components, then sudden changes of 0°, 90° and −90° can be compensated for using just one multiplexer and an inverter as shown in FIG. 7.

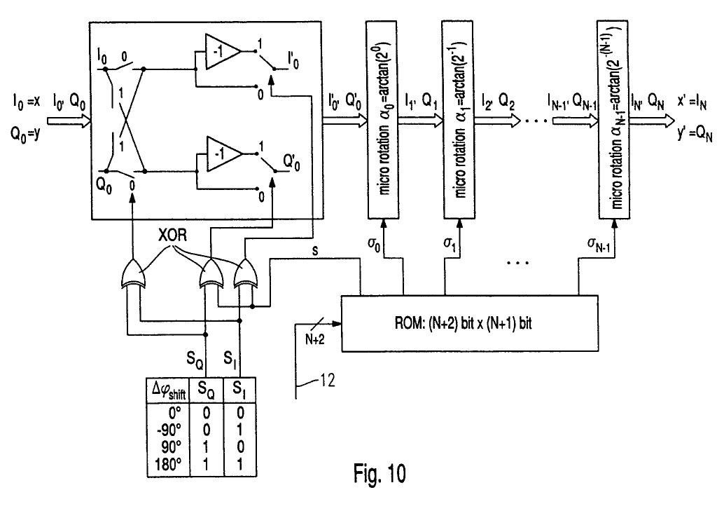

c) The arrangements from a) or b) as shown in FIG. 6 and FIG. 7 can be combined particularly advantageously with a frequency correction element which uses the CORDIC algorithm, since the CORDIC structure already contains an inverter. Merely a second control signal is required, as FIG. 10 shows.

The further embodiments are explained in more detail below with reference to the figures of the drawing.

FIG. 2 shows an arrangement which, as a complement to FIG. 1, contains further elements for joint implementation with an additional frequency correction section.

The system control unit 10 first uses the connection 101 to change over the gain factor and programs the appropriate correction value Δφ_{SHIFT} 103. If the resultant sudden phase change arises in the input signal x+jy, the multiplexer 24 is put into switch position 1 by means of the control signal 102 for the duration of an adding cycle. The effect achieved by this is that the sudden phase change is permanently compensated for in the phase accumulator by virtue of the single addition of the correction value using the adder 23. In the remaining time, the multiplexer 24 is in position 0, i.e. no further phase correction is performed.

FIG. 3 shows an arrangement which, in contrast to FIG. 2, uses just a single adder 21 in order to minimize complexity, but in return the system control unit 10 needs to provide a value Δφ′_{SHIFT}=Δφ′_{SHIFT}+Δφ′_{INC} which is modified in line with the frequency correction taking place at the same time, which is generally not a drawback, however. The operation of the multiplexer is identical to the variant shown in FIG. 2.

FIG. 4 shows the most general embodiment of the unit for correcting sudden phase changes or for frequency correction 20 shown in FIG. 2 or FIG. 3 in the form of a complex-value multiplier which rotates the complex-value input signal x+jy through an angle 12 (phase) Δφ_{SHIFT} and outputs the complex-value output signal x′+jy′.

FIG. 5 shows the structure of a multiplier-free arrangement for the unit for phase and frequency correction 20 shown in FIG. 2 or FIG. 3, which operates on the basis of the CORDIC method, as described by way of example in German laid-open specification DE 199 48 899 A1, which is incorporated hereby, particularly with regard to the CORDIC algorithm, in its entirety in the disclosed content of the present application. The input signal, which determines the phase used, is the output signal from the phase accumulator 12 from FIG. 2 or FIG. 3. The signal s is logic 1 when the arithmetic signs of the input signals need to be reversed.

FIG. 6 shows a specific, particularly low-complexity embodiment of the unit for correcting sudden phase changes 20 which is shown in FIG. 1, which is suitable for correcting sudden phase changes of 0°, 90° or −90°. The three different phase values are coded using the multiplexer positions 0, 1 and 2.

FIG. 7 likewise shows a specific, particularly low-complexity embodiment of the unit for correcting sudden phase changes 20 which is shown in FIG. 1, which is suitable for correcting sudden phase changes of 0°, 90° or −90° if the normal (I) and quadrature (Q) components are present and processed through time-division multiplexing. In the 90° and −90° case, the subsequent processing unit then interprets timeslots which were previously associated with the normal component as a quadrature component, and vice versa. In this context, the inverter inverts every second data value.

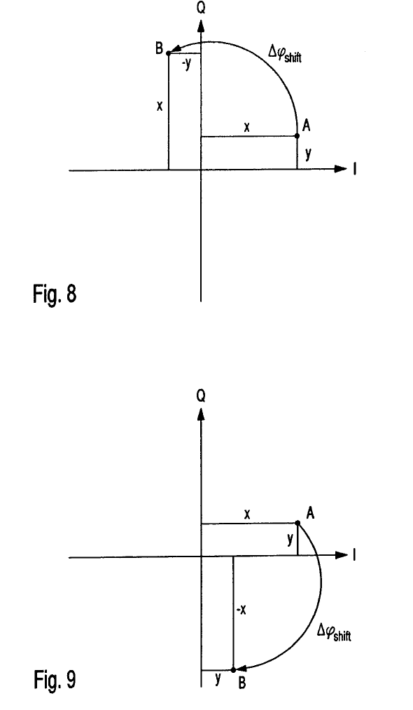

FIG. 8 and FIG. 9 illustrate how the arrangements shown in FIG. 6 and FIG. 7 perform the phase rotations at point A through 90° and −90° with respect to point B.

The arrangement in FIG. 6 can be combined particularly advantageously with a frequency correction element which uses the CORDIC algorithm since the CORDIC structure in FIG. 5 already contains an inverter. Merely one second control signal is required for arithmetic-sign inversion, as FIG. 10 shows. In the block in FIG. 10, which represents the arithmetic-sign reversal, the arithmetic signs can now be inverted separately for I and Q as compared with FIG. 5. In addition, the arrangement has been extended by an intermediate switch which transposes the input signals if the associated control signal is logic 1. In addition to the phase value 12, which is provided by the phase accumulator for the purpose of frequency correction, two further control signals S_{I} and S_{Q} are provided by the system control unit in the present exemplary embodiment instead of the value Δφ_{SHIFT}, the two further control signals representing the value 0°, −90°, 90° or 180° of the sudden phase change which needs to be corrected. In contrast to the exemplary embodiment in FIG. 2 or FIG. 3, these control signals need to be applied permanently. The control signals for the intermediate switch and for the multiplexers can be obtained from the signals s, S_{I} and S_{Q} through simple logic combination using an XOR gate, as FIG. 10 shows.

1. An apparatus for correcting sudden phase changes in received signals in mobile stations, wherein
the mobile station's reception path comprises switchable components having at least two switchable states which produce sudden phase changes in the received signal upon changeover,
these sudden phase changes being able to be corrected by a device for phase correction, and
a system control unit transmits the parameters required for this, particularly the level of the sudden phase change and the time of the sudden phase change, to the device for phase correction.

2. The apparatus as claimed in claim 1, wherein
the system control unit is designed such that it changes over the switchable components, particularly the gain factor for the amplifier stage, and that it uses this property to determine the time of the sudden phase change.

3. The apparatus as claimed in claim 1, wherein
the unit for phase correction simultaneously performs both correction of sudden phase changes and frequency correction.

4. The apparatus as claimed in claim 1, wherein
the unit for phase correction contains a structure which is based on the principle of the CORDIC algorithm.

5. The apparatus as claimed in claim 1, wherein
the unit for phase correction contains a structure which specifically implements phase corrections of 0°, 90° and −90° or else 180° without a multiplier.

6. The apparatus as claimed in claim 5, wherein
precisely one multiplexer is provided for processing the normal and quadrature components using time-division multiplexing.

7. The apparatus as claimed in claim 5, wherein
the unit for phase correction by 0°, 90°, −90° or 180° is combined with a unit for frequency correction which is based on the principle of the CORDIC algorithm.

8. The apparatus as claimed in claim 5, wherein
the unit for phase correction by 0°, 90°, −90° or 180° is implemented using means for analog signal processing and, in particular, is integrated on the chip which contains the switchable analog components.

9. The apparatus as claimed in claim 1, wherein
the apparatus is integrated in the same chip as the digital signal receiver.

10. A mobile station having an apparatus for correcting sudden phase changes in received signals in mobile stations, wherein the mobile station's reception path comprises switchable components having at least two switchable states which produce sudden phase changes in the received signal upon changeover, wherein these sudden phase changes being able to be corrected by a device for phase correction, and wherein a system control unit transmits the parameters required for this, particularly the level of the sudden phase change and the time of the sudden phase change, to the device for phase correction, wherein the apparatus supports, in particular, the standards UMTS FDD, UMTS TDD, GSM (GMSK modulation), EDGE (3π/8-8 PSK modulation) and also TIA/EIA-136 (π/4-DQPSK modulation or 8-PSK modulation) or part combinations thereof.

11. A method for correcting sudden phase changes in received signals in mobile stations, comprising the steps of:
producing in the mobile station's reception path sudden phase changes in the received signal when switchable components having at least two switchable states change over, and
correcting the sudden phase changes by a device for phase correction, and transmitting the parameters required for this by a system control unit, particularly the level of the sudden phase change and the time of the sudden phase change, to the device for phase correction.

12. The method as claimed in claim 11, wherein
the system control unit also changes over the switchable components, particularly the gain factor for the amplifier stage, and, in particular, uses this property to determine the time of the sudden phase change.

13. The method as claimed in claim 11, wherein
the unit for phase correction simultaneously performs both correction of sudden phase changes and frequency correction.

14. The method as claimed in claim 11, wherein
the unit for phase correction contains a structure which is based on the principle of the CORDIC algorithm.

15. The method as claimed in claim 11, wherein
the unit for phase correction contains a structure which specifically implements phase corrections of 0°, 90° and −90° or else 180° without a multiplier.

16. The method as claimed in claim 15, wherein
the normal and quadrature components are processed using time-division multiplexing, and only one multiplexer is used.

17. The method as claimed in claim 15, wherein
the unit for phase correction by 0°, 90°, −90° or 180° is combined with a unit for frequency correction which is based on the principle of the CORDIC algorithm.

18. The method as claimed in claim 15, wherein
the unit for phase correction by 0°, 90°, −90° or 180° is implemented using means for analog signal processing and, in particular, is integrated on the chip which contains the switchable analog components.

19. The method as claimed in claim 11, wherein
the arrangement or the method is integrated in the same chip as the digital signal receiver.

20. The method as claimed in claim 11, wherein
the method is used in mobile stations which support, in particular, the standards UMTS FDD, UMTS TDD, GSM (GMSK modulation), EDGE (3π/8-8 PSK modulation) and also TIA/EIA-136 (π/4-DQPSK modulation or 8-PSK modulation) or part combinations thereof.
